(19) United States
(12) Patent Application Publication
(10) Pub. No.: US 2015/0205560 A1
(43) Pub. Date: Jul. 23, 2015

(54) DISPLAY SCREEN WITH VARIABLE SIZE, MOBILE TERMINAL AND IMPLEMENTATION METHOD THEREOF

(71) Applicant: HUIZHOU TCL MOBILE COMMUNICATION CO., LTD., HUIZHOU (CN)

(72) Inventor: Shiqing Zhao, Huizhou (CN)

(21) Appl. No.: 14/422,514

(22) PCT Filed: Apr. 16, 2014
(86) PCT No.: PCT/CN2014/075517

§ 371 Date: Feb. 19, 2015

(30) Foreign Application Priority Data
Jul. 3, 2013 (CN) 201310276327.7

(51) Int. Cl. G06F 3/147; H04M 1/02; G06F 3/14

(52) U.S. Cl. CPC G06F 3/147; G06F 3/1423; H04M 1/0266

(57) ABSTRACT

The present disclosure relates to a display screen with variable size, a mobile terminal and an implementation method thereof. The display screen with variable size may include a main display screen and a folding screen. The main display screen and the folding screen may be rotatably connected, and a sensor may be arranged between the main display screen and the folding screen for sensing a state of the folding screen. The sensor may be used to sense the state of the folding screen such that the folding screen, when it is unfolded, displays together with the main display screen, and such that the main display screen displays by itself when the folding screen is folded. Thereby, a variable size of the display screen is provided. When the display screen size is increased, the display screen may, for example, be equivalent to a screen of a tablet computer. When the display screen size is decreased the display screen may, for example, be equivalent to a screen of a smartphone.

### TECHNICAL FIELD

The present disclosure relates to the field of mobile terminal technologies and, in particular to a display screen with variable size, a mobile terminal and an implementation method thereof.

### BACKGROUND

According to development trends of smartphones and smart tablets, screen size of an intelligent terminal may directly impact a use state of a terminal user. For example, in a portable and mobile intelligent terminal, such as a smartphone, the portable terminal is easy to carry around and convenient for making phone calls and sending messages. On the other hand, a tablet computer makes it convenient for the user to go online, watch movies and play games due to a relatively big screen. While bringing wonders and happiness to people's life, intelligent mobile terminals also cause inconvenience to people. For example, people need to carry both a cell phone, with a relatively small screen, and a tablet computer, with a relatively big screen, at the same time. Such inconvenience encourages development of a novel mobile terminal with advantages of both of the above two types of intelligent mobile terminals.

Furthermore, due to the rapid development of semiconductor technologies, electronic components and parts, used by tablet computers and cell phones, are highly integrated, have increasingly small sizes, and occupy very small space in cell phones and tablet computers. In comparison to other portions of a mobile terminal, a display screen takes up the biggest space and, if the display screen size issue could be solved, a tablet computer can have a display screen that folds to a size of a cell phone display screen, and a cell phone display screen can also be unfolded to a size of a tablet computer.

Moreover, smartphones and tablet computers are not substantially different from one another, aside from screen size. Thus, in order for these two types of intelligent terminals to be designed into one intelligent terminal, an associated display screen needs to have a variable size.

### SUMMARY

In light of the shortcomings of the prior art, the object of the present invention is to provide a display screen with variable size, a mobile terminal and an implementation method thereof. The invention is intended to solve the problem of inconvenient portability in the prior art that, to obtain different user experiences, a user needs to carry mobile terminals with big and small screens at the same time.

The present invention employs the following technical solutions:

A display screen with variable size includes a main display screen and a folding screen; wherein the main display screen and the folding screen are rotatably connected, and a sensor is arranged between the main display screen and the folding screen for sensing a state of the folding screen.

In another embodiment, a display screen with variable size includes two folding screens, which are each arranged at a respective side of the main display screen.

In a further embodiment, a display screen with variable size includes a rotating shaft and a flexible cord arranged between the main display screen and the folding screen: the rotating shaft is for rotation of the folding screen when the folding screen is folded and unfolded; the flexible cord connects the main display screen to the folding screen.

In yet a further embodiment, a display screen with variable size includes a sensor that is either a compression sensor or a proximity sensor.

In another embodiment, a display screen with variable size includes unfolding the folding screen to increase a display area and folding the folding screen to decrease the display area.

In another embodiment, a mobile terminal includes a display screen having a main display screen and a folding screen; wherein the main display screen and the folding screen are rotatably connected, and a sensor is arranged between the main display screen and the folding screen for sensing a state of the folding screen; and a control chip, wherein the sensor is connected to the control chip.

In a further embodiment, a mobile terminal includes a sensor having a sensing device, a first resistor and a first switch, wherein a moving contact point of the first switch is connected to the sensing device of the sensor via an elastic part, a base point of the first switch is grounded, a static contact point of the first switch is divided into a first path that is connected to a power supply terminal of the control chip via the first resistor, and a second path that is connected to a general input/output port of the control chip.

In yet a further embodiment, a method for varying a size of a display in a mobile terminal includes providing a sensor arranged between the main display screen and the folding screen for sensing a state of the folding screen, wherein the sensor is connected to a control chip, wherein the sensor comprises a sensing device, a first resistor and a first switch, wherein a moving contact point of the first switch is connected to the sensing device of the sensor via an elastic part, wherein a base point of the first switch is grounded, and wherein a static contact point of the first switch is divided into a first path that is connected to a power supply terminal of the control chip via the first resistor and a second path that is connected to a general input/output port of the control chip; when a folding screen is in an unfolded state, information of the unfolded state, sensed by the sensor, is transmitted to the control chip, and the control chip activates a display of the corresponding folding screen, such that the folding screen and the main display screen display together; and when the folding screen is in a folded state, information of the folded state, sensed by the sensor, is transmitted to the control chip, and the control chip shuts down the display of the corresponding folding screen, such that the main display screen displays.

In yet a further embodiment, a method for varying a size of a display in a mobile terminal includes a compression sensor, wherein when the folding screen is in an unfolded state, the compression sensor is turned on and, according to an on state of the compression sensor, a general input/output port of the control chip activates the display of the folding screen, such that the folding screen and the main display screen display together.

In another embodiment, a method for varying a size of a display in a mobile terminal includes a compression sensor and, when the folding screen is in a folded state, the compression sensor is turned off, and according to an off state of the compression sensor, a general input/output port of the control chip shuts down the display of the corresponding folding screen, such that only the main display screen displays.

In a further embodiment, a method for varying a size of a display in a mobile terminal includes a main display screen that displays together with a first folding screen located on a left side of the main display screen, and the main display screen displays together with a second folding screen located on a right side, or the main display screen displays together with the first and second folding screens.

The present invention provides a display screen with variable size, a mobile terminal and method of varying a display size thereof, which senses a state of the folding screen with a sensor, such that the folding screen, when it is unfolded, displays together with the main display screen; and the main display screen displays by itself when the folding screen is folded. Thereby, a variable size of the display screen is achieved. When a folding screen is unfolded, a combination of a main display screen and the folding screen is equivalent to a size of a display screen of a tablet computer, which may be used by a user to watch videos and play games. When a folding screen is folded, a main display screen is equivalent to a display screen of a smartphone, which makes it convenient for a user to carry and hold in hand to dial a call.

### BRIEF DESCRIPTION OF THE DRAWINGS

FIG. 1 is a structural block diagram of a display screen with variable size according to the present invention;

FIG. 2 illustrates an embodiment of a display screen with variable size according to the present invention;

FIG. 3 illustrates folding screens in an unfolded state in an embodiment of a display screen with variable size according to the present invention;

FIG. 4 illustrates folding screens in a folded state in an embodiment of a display screen with variable size according to the present invention;

FIG. 5 illustrates a connection between a sensor and a control chip in an embodiment of a mobile terminal according to the present invention;

FIG. 6 is a flow chart of a method for varying a display size of a mobile terminal according to the present invention.

### DETAILED DESCRIPTION

The present invention provides a display screen with variable size, a mobile terminal having a display screen with a variable size, and a method of varying a size of a display screen thereof. To make the objectives, technical solutions and effects of the present invention clearer and more specific, the present invention is described in detail below. It should be understood that the specific embodiments, as described herein, are included for illustrative purposes. The specific embodiment are not intended to limit the present invention in any way.

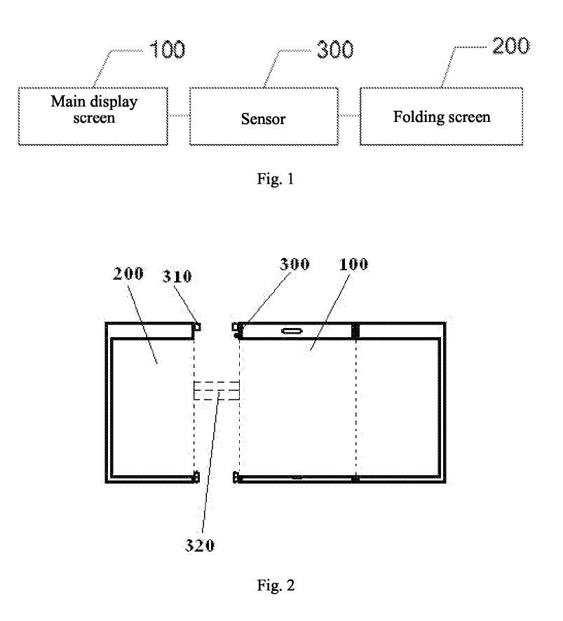

Turning to FIG. 1, a structural block diagram of a display screen with variable size is depicted. The display screen may include a main display screen 100 and a folding screen 200. The main display screen 100 and the folding screen 200 may be rotatably connected, and a sensor 300 may be arranged between the main display screen 100 and the folding screen 200 for sensing a state of the folding screen.

A size of the screen display may be varied by folding and unfolding of the folding screen(s). A folding screen may be unfolded to increase a display area, and an associated display effect may be equivalent to a display effect of a tablet computer. A folding screen may be folded to decrease a display area, and an associated display effect may be equivalent to a display effect of a smartphone, which makes the associated portable terminal convenient to carry, to dial a call and to send messages.

The sensor 300 may be a compression sensor or a proximity sensor. With respect to a compression sensor, a shape of the compression sensor may be changed through two states by opening or closing a main display screen and a folding screen. The compression sensor may be equivalent to, for example, a switch. When a folding screen 200 is unfolded, a compression force between a main display screen 100 and the folding screen 200 may connect, and turn on, the compression sensor. A control chip may detect the connected sensor and may determine that the folding screen 200 has been unfolded In turn, the control chip may activate a display on the folding screen 200. Similarly, when the folding screen 200 is closed (also referred to as unfolded), the compression force between the main display screen 100 and the folding screen 200 may disappear, such that the compression sensor 300 between the main display screen 100 and the folding screen 200 may change from a connection state to a disconnection state, thus the control chip may detect the disconnected sensor 300 and may determine that the folding screen 200 has been folded. Thereby, the control chip may shut down the display on the folding screen 200.

A proximity sensor, as an alternative sensor 300, may operate according to a principle of Hall Effect, which may use a switch-type Hall sensor to sense unfolding and folding of the folding screen. Since a principle of Hall Effect is known, the principle of Hall Effect will not be described herein.

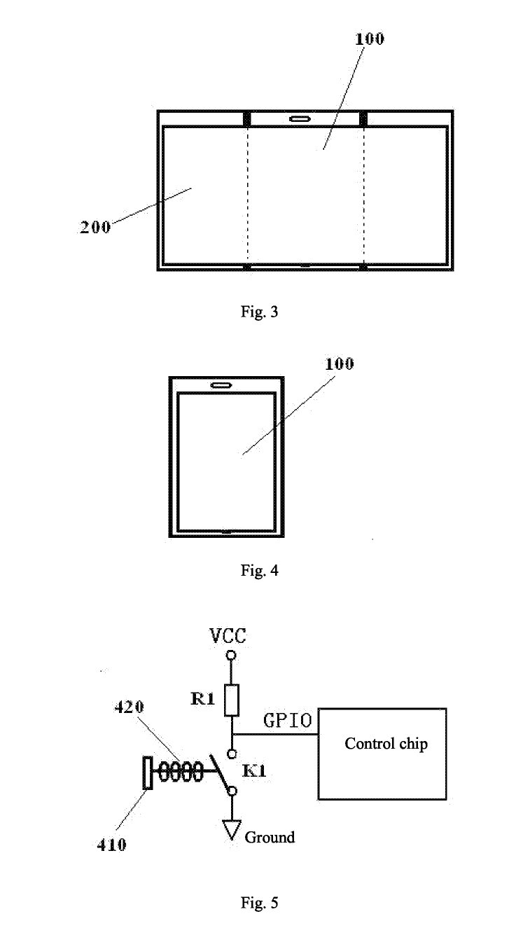

With reference to FIG. 2, a display screen may include a main display screen 100 and two folding screens 200, each folding screen 200 may be arranged at a respective side of the main display screen 100. A rotating shaft 310 and a flexible cord 320 may be arranged between the main display screen 100 and the folding screen 200. The rotating shaft 310 may be for rotation of the folding screen when it is folded and unfolded. The flexible cord 320 may connect the main display screen 100 to the folding screen 200. The sensor 300 may be a compression sensor (also referred to as a squeeze sensor), which may be located at a side of the main display screen 100 that is connected with the folding screen 200. When the folding screen 200 is unfolded, as shown in FIG. 3, the folding screen 200 may squeeze the sensor 300, such that the sensor 300 senses a state change of the folding screen 200. Thereby, a display state of the display screen may be updated such that, for example, the folding screen 200 may display together with the main display screen 100.

When the folding screen is folded (also referred to as being in the folded state, as shown in FIG. 4), the sensor between the folding screen and the main display screen 100 may change from a squeezed state to the ejected state. Thereby, a display state of the display screen by, for example, having the main display screen 100 display by itself.

A mobile terminal may include a display screen with variable size, as described above, and a control chip. A sensor may be connected to the control chip. With respect to the mobile terminal, the display screen may be ordinarily folded together (i.e. the folding screens are in the folded state), such that the mobile terminal is convenient to carry and to make phone calls, similar to, for example, a standard smartphone. When a big screen is desired for display, e.g., watching movies or playing games, the folding screen(s) may be unfolded such that the display screen is similar to a display screen of a tablet computer. When a big screen display is not desired, the folding screen(s) may be folded for convenient carry and storage.

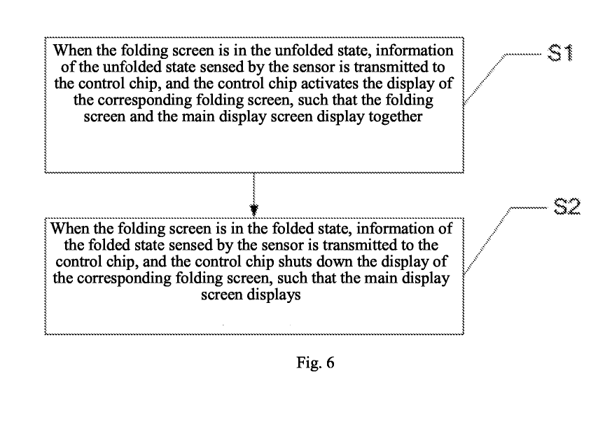

A method of varying a display size for the above mobile terminal (i.e. a method for implementing the variable size of a display screen), as shown in FIG. 6, includes, when the folding screen is in an unfolded state, information of the unfolded state, sensed by a sensor, may be transmitted to a control chip. The control chip may activate a display of the corresponding folding screen, such that the folding screen and the main display screen display together. When the folding screen is in the folded state, information of the folded state, sensed by the sensor, may be transmitted to the control chip, and the control chip may shut down the display of the corresponding folding screen, such that only the main display screen displays.

Turning to FIG. 5, a sensor 300 may include a sensing device 410, a first resistor R1 and a first switch K1. A moving contact point of the first switch K1 may be connected to the sensing device 410 of the sensor via an elastic part 420. A base point of the first switch K1 may be grounded. A static contact point of the first switch K1 may be divided into a first path, that may be connected to the power supply terminal VCC of the control chip via the first resistor R1, and a second path that may be connected to a general input/output port GPIO of the control chip.

A variable size of a display screen may be implemented by use of a sensor and a control chip. For ease of illustration, use of a compression sensor is described. It should be understood that implementation of a proximity sensor may replace a compression sensor, and operation of a proximity sensor may be achieved mainly according to the principle of Hall Effect, which may use a switch-type Hall sensor to sense unfolding and folding of an associated folding screen. The principle of operation of a proximity sensor may be substantially similar to a squeeze sensor, aside from the fact that a switch of a proximity sensor may be a Hall element.

When a folding screen is in an unfolded state, a compression force, between a main display screen and the folding screen, may act on the sensing device 410, and may displace a moving contact point of a first switch K1 to be in contact with a static contact point via an elastic part 420 (e.g., the elastic part may be a spring), such that the first switch K1 may be turned on. When the first switch K1 is turned on, a general input/output port (GPIO) of an associated control chip may be grounded, i.e., a level of the general input/output port (GPIO) may be lowered (from a high level to a low level). When the control chip detects that the general input/output port (GPIO) changes from a high level to a low level, the control chip may activate a display of a corresponding folding screen, such that the folding screen and the main display screen may display together.

Similarly, when the folding screen is in the folded state, a compression force between the main display screen and the folding screen may disappear. Under an action of the elastic part 420, the moving contact point and the static contact point, of the first switch K1, may be separated such that the first switch K1 may be turned off. When the first switch K1 is turned off, the general input/output port (GP10) of the control chip may be connected to a power supply terminal (VCC) of the control chip via a first resistor R1, a level of the general input/output port (GP10) may be raised (from a low level to a high level). When the control chip detects that the general input/output port (GP10) changes from a low level to a high level, the control chip may shut down a display of a corresponding folding screen, such that only the main display screen displays.

As described above, a compression sensor includes a first state (e.g., an on state) for a folding screen in an unfolded state and a second state (e.g., an off state) for the folding screen in the folded state.

When the folding screen is in the unfolded state, a compression force between the main display screen and the folding screen may connect, and may turn on the compression sensor. According to the detected connection, and/or the on state of the compression sensor, the general input/output port of the control chip may activate the display of the corresponding folding screen, such that the folding screen and the main display screen display together.

When the folding screen is in the folded state, there may be no compression between the main display screen and the folding screen, which may lead to disconnection of the compression sensor between the two. According to the detected disconnection state of the compression sensor, the general input/output port of the control chip may shut down the display of the corresponding folding screen, such that only the main display screen displays.

It should be understood that when there are a plurality of the folding screens, each folding screen may be unfolded or folded according to a user need, and the control chip may choose a software drive according to the state of the respective folding screen. When two folding screens are included, a control chip may include, for example, four software drives, i.e. a main screen drive; a second drive after the main screen is added with the right folding screen; a third drive after the main screen is added with the left folding screen; a fourth drive after the main screen is added with the right folding screen and the left folding screen. A software drive may cause the control chip to confirm a display size according to a display screen state detected by a sensor switch, and may display display content according to an actual display size. Thus, the main display screen displaying together with the folding screens may include, for example, that the main display screen displays together with a folding screen at a left side of the main display screen, the main display screen displays together with a folding screen at a right side of the main display screen, or the main display screen displays together with folding screens at both sides thereof.

In summary, the present invention provides a display screen with variable size, a mobile terminal including a display screen with variable size, and a method of varying a size of a display thereof. The display screen with variable size may include a main display screen and a folding screen. The main display screen and the folding screen may be rotatably connected to one another, and a sensor may be arranged between the main display screen and the folding screen for sensing the state of the folding screen. The sensor may be used to sense a state of the folding screen such that the folding screen, when it is unfolded, displays together with the main display screen; and the main display screen displays by itself when the folding screen is folded. Thereby, variable size of the display screen may be achieved. When the screen size is increased, the screen size may be equivalent to a display screen of a tablet computer, which may be used to watch videos and play games. When the screen size is decreased, the screen size may be equivalent to a display screen of a smartphone, which makes it convenient for a user to carry and hold in hand to dial a call.

It should be understood that applications of the present invention are not limited to the above examples. To those skilled in the art, improvements or modifications may be made according to the above description, and all of these improvements or modifications shall be considered to be within the scope of the appended claims.

1. A display screen with variable size, the display screen comprising:
a main display screen and a folding screen,
wherein the main display screen and the folding screen are rotatably connected to one another, and a sensor is arranged between the main display screen and the folding screen for sensing a state of the folding screen.

2. The display screen according to claim 1, comprising: two folding screens, wherein each folding screen is arranged at a respective side of the main display screen.

3. The display screen according to claim 1, further comprising: a rotating shaft and a flexible cord that are arranged between the main display screen and the folding screen, wherein the rotating shaft is for rotation of the folding screen when the folding screen is folded and unfolded and wherein the flexible cord connects the main display screen to the folding screen.

4. The display screen according to claim 1, wherein the sensor is either a compression sensor or a proximity sensor.

5. A display screen according to claim 1,
wherein the folding screen is
unfolded to increase a display area and the folding screen is folded to decrease the display area.

6. The display screen according to claim 5, comprising: two folding screens, wherein each folding screen is arranged at a respective side of the main display screen.

7. The display screen according to claim 5, further comprising: a rotating shaft and a flexible cord are arranged between the main display screen and the folding screen, wherein the rotating shaft is for rotation of the folding screen when the folding screen is folded and unfolded, and wherein the flexible cord connects the main display screen to the folding screen.

8. The display screen according to claim 5, wherein the sensor is either a compression sensor or a proximity sensor.

9. A mobile terminal, comprising:
a main display screen and a folding screen, wherein the main display screen and the folding screen are rotatably connected to one another; and
a sensor arranged between the main display screen and the folding screen for sensing a state of the folding screen, wherein the sensor is connected to a control chip.

10. The mobile terminal according to claim 9, wherein the sensor comprises a sensing device, a first resistor and a first switch, wherein a moving contact point of the first switch is connected to the sensing device of the sensor via an elastic part, wherein a base point of the first switch is grounded, and wherein a static contact point of the first switch is divided into a first path that is connected to a power supply terminal of the control chip via the first resistor and a second path that is connected to a general input/output port of the control chip.

11. A method for varying a size of a display in a mobile terminal, the method comprising:
providing a main display screen and a folding screen, wherein the main display screen and the folding screen are rotatably connected to one another;
providing a sensor arranged between the main display screen and the folding screen for sensing a state of the folding screen, wherein the sensor is connected to a control chip, wherein the sensor comprises a sensing device, a first resistor and a first switch, wherein a moving contact point of the first switch is connected to the sensing device of the sensor via an elastic part, wherein a base point of the first switch is grounded, and wherein a static contact point of the first switch is divided into a first path that is connected to a power supply terminal of the control chip via the first resistor and a second path that is connected to a general input/output port of the control chip;
when the folding screen is in an unfolded state, information of the unfolded state sensed by the sensor is transmitted to the control chip, and the control chip activates a display of the folding screen, such that the folding screen and the main display screen display together; and
when the folding screen is in a folded state, information of the folded state sensed by the sensor is transmitted to the control chip, and the control chip shuts down the display of the folding screen, such that the main display screen displays.

12. The method according to claim 11, wherein the sensor is a compression sensor,
and when the folding screen is in the unfolded state, the compression sensor is in an on state; and
according to the detected on state of the compression sensor, the general input/output port of the control chip activates the display of the folding screen, such that the folding screen and the main display screen display together.

13. The method according to claim 11, wherein the sensor is a compression sensor, and
when the folding screen is in a folded state, the compression sensor is in an off state; and
according to the off state of the compression sensor, the general input/output port of the control chip shuts down the display of the corresponding folding screen, such that only the main display screen displays.

14. The method according to claim 11, wherein when two folding screens and the main display screen are displaying together, the main display screen displays together with a first folding screen at a left side of the main display, and the main display screen displays together with a second folding screen at a right side of the main display, or the main display screen displays together with the first and second folding screens at both the right and left sides, respectively, thereof.

15. The method according to claim 11, wherein the sensor is either a compression sensor or a proximity sensor.

16. A mobile terminal according to claim 9, wherein the folding screen is unfolded to increase a display area and the folding screen is folded to decrease the display area.

17. The mobile terminal according to claim 9, comprising: two folding screens, wherein each folding screen is arranged at a respective side of the main display screen.

18. The mobile terminal according to claim 9, further comprising: a rotating shaft and a flexible cord are arranged between the main display screen and the folding screen, wherein the rotating shaft is for rotation of the folding screen when the folding screen is folded and unfolded, and wherein the flexible cord connects the main display screen to the folding screen.

19. The mobile terminal according to claim 9, wherein the sensor is either a compression sensor or a proximity sensor.

20. The mobile terminal according to claim 9, wherein when two folding screens and the main display screen are displaying together, the main display screen displays together with a first folding screen at a left side of the main display, and the main display screen displays together with a second folding screen at a right side of the main display, or the main display screen displays together with the first and second folding screens at both the right and left sides, respectively, thereof.
